(19) United States
(12) Patent Application Publication
(10) Pub. No.: US 2004/0098505 A1
(43) Pub. Date: May 20, 2004

(54) Forwarding system with multiple logical sub-system functionality

(76) Inventor: Daniel G. Clemmensen, Great Falls, VA (US)

Correspondence Address: Ralph A. Dowell, DOWELL & DOWELL, P.C., Suite 309, 1215 Jefferson Davis Highway, Arlington, VA, 22202, US

(21) Appl. No.: 10/299,857

(22) Filed: Nov. 20, 2002

(51) Int. Cl. G06F 15/173

(52) U.S. Cl. 709/244

(57) ABSTRACT

Generation of a mapping for use by a data forwarding entity having communication interfaces and instantiating multiple logical forwarding sub-systems associated with respective mappings including a first mapping and a second mapping. The first mapping specifies a next hop interface for data elements received at the interfaces, at least one next hop interface belonging to a set of logical interfaces. The second mapping specifies a second next hop interface for certain data elements for which the next hop interface specified by the first mapping belongs to the set of logical interfaces, at least one second next hop interface belonging to the plurality of communication interfaces. A consolidated mapping is created by replacing each portion of the first mapping that specifies a next hop interface belonging to the set of logical interfaces by a corresponding portion of the second mapping that specifies a second next hop interface. Efficiency arises when the same data is processed by more than one logical forwarding sub-system in the same physical forwarding system.

### FIELD OF THE INVENTION

The present invention relates generally to data communications forwarding systems and, more particularly, to a data forwarding apparatus capable of exhibiting the functionality of multiple interconnected logical forwarding sub-systems while maintaining efficient usage of its communication interfaces.

### BACKGROUND OF THE INVENTION

Modern data communications forwarding systems (e.g., switches and routers) typically have functionality that is partitioned into a “control plane” and a “data plane.” The control plane is typically implemented using hardware that can execute complex software written in general-purpose languages to implement control protocols and operator interfaces. The data plane is implemented in special-purpose hardware, with forwarding and processing decisions implemented in different ways on different systems. Even when the data plane processing is implemented in a general-purpose CPU, the data plane is typically treated as a separate entity and is optimized for efficient forwarding.

Examples of forwarding systems having functionality partitioned into a control plane and a data plane include IP routers, layer-2 switches of various types (e.g., Ethernet, Frame Relay (FR), Asynchronous Transfer Mode (ATM), Multi-Protocol Label Switching (MPLS)), circuit switches of various types (e.g., DACS, Synchronous Optical Network (SONET) Add-Drop Multiplexers (ADMs), Optical Cross-Connects (OXCs)), wireless telephony equipment, equipment that performs combinations of the above operations and most other programmable communications equipment that performs a forwarding function. Examples of processing accomplished by the data plane include label lookup (MPLS, FR, ATM, X.25), source lookup (Ethernet, Internet Protocol (IP)), destination lookup (Ethernet, IP), egress interface lookup (all switching types), egress sub-interface lookup (most switching types), encapsulation (most switching types), filtering, metering, statistics accumulation and sampling.

It is often desirable to partition a single physical forwarding system into multiple logical forwarding sub-systems. For example, a service provider may wish to provide a router for each customer without actually installing a separate piece of equipment for each customer. Alternatively, in a forwarding system that performs two functions (e.g., IP routing and Frame Relay switching) it may be easier to implement logically separate control planes for the two functions. In yet another scenario, as in a large IP network, it is desirable to logically partition the network into a hierarchy, with different functionality in the routers within each layer of the hierarchy. When routers of different layers are co-located, it is advantageous to instantiate two or more logical forwarding sub-systems in a single physical forwarding system.

Existing implementations of multiple logical forwarding sub-systems in the same hardware operate by instantiating a separate instance of the data plane processing for each sub-system. When data must logically be processed sequentially by two or more logical forwarding sub-systems, the data is passed sequentially from the instance of the first data plane to the instance of the next data plane until it reaches the instance of the last data plane. Moreover, a typical implementation divides the ingress and egress interfaces of the physical system among the logical forwarding sub-systems. All input on an ingress that belongs to a particular sub-system is first processed by that sub-system. When a physical port uses a protocol that can differentiate the data in some manner at a low level, (e.g. by TDM or using labels) then the individual data streams may be handled by different logical forwarding sub-systems.

However, the partitioning of interfaces of the physical forwarding system amongst the logical forwarding sub-systems has a significant drawback. Specifically, since the logical forwarding sub-systems are connected amongst themselves, each such connection will consume a pair of interfaces of the physical forwarding system. Hence, a significant proportion of the interfaces of the physical forwarding system may be taken up by the connections amongst the logical forwarding sub-systems, which results in highly inefficient interface usage. This effectively means that a single physical forwarding system, which is assigned to play the role of a plurality of logical forwarding sub-systems, will need to be over-provisioned at the interface level. This represents an inconvenience to the service provider, at least in the form of added cost.

### SUMMARY OF THE INVENTION

The present invention is applicable to forwarding systems of the type where data is logically processed first by the data plane of one of a plurality of logical forwarding sub-systems, and then by the data plane of another of the sub-systems. By extension, the present invention is also applicable when the data planes of three or more logical forwarding sub-systems must sequentially process the same data. The present invention relates to creation of a consolidated mapping function that is based on the individual mapping functions that specify the forwarding behaviour of the individual logical routers. This concept enables efficient shared data-plane operation in a forwarding system that instantiates multiple logical forwarding sub-systems. The efficiency arises when the same data is processed by more than one logical forwarding sub-system in the same physical forwarding system. The concept is applicable to systems with centralized or distributed data planes. It is also applicable to systems with centralized or distributed control planes.

According to a broad aspect, the invention provides a method of generating a mapping for use by a data forwarding entity having a plurality of communication interfaces. The method includes receiving a first mapping specifying a next hop interface for data elements received at the communication interfaces, wherein at least one next hop interface belongs to a set of logical interfaces. The method also includes receiving a second mapping specifying a second next hop interface for certain data elements for which the next hop interface specified by the first mapping belongs to the set of logical interfaces, wherein at least one second next hop interface belongs to the plurality of communication interfaces. Further, the method includes generating a consolidated mapping from the first and second mappings by replacing each portion of the first mapping that specifies a next hop interface belonging to the set of logical interfaces by a corresponding portion of the second mapping that specifies a second next hop interface.

According to another broad aspect, the present invention may be summarized as a data forwarding apparatus. The data forwarding apparatus includes a plurality of communication interfaces at which data elements are received by the apparatus, a memory and a processing entity connected to the communication interfaces and to the memory. The memory stores a first mapping, a second mapping and a consolidated mapping. The first mapping specifies a next hop interface for data elements received at the communication interfaces, wherein at least one next hop interface belongs to a set of logical interfaces. The second mapping specifies a second next hop interface for certain data elements for which the next hop interface specified by the first mapping belongs to the set of logical interfaces, wherein at least one second next hop interface belongs to the plurality of communication interfaces. The consolidated mapping specifies a next hop interface for data elements received at the communication interfaces, wherein no next hop interface specified by the consolidated mapping belongs to the set of logical interfaces. The processing entity generates the consolidated mapping from the first and second mappings by replacing each portion of the first mapping that specifies a next hop interface belonging to the set of logical interfaces by a corresponding portion of the second mapping that specifies a second next hop interface. Additionally, the processing entity accesses the consolidated mapping to determine a next hop interface associated with each data element received at the communication interfaces and forwards the received data element to the next hop interface determined at the accessing step.

According to yet another broad aspect, the present invention may be summarized as a memory for storing data for access by an application program being executed on a data processing system having a plurality of communication interfaces. The memory includes a data structure stored in the memory that includes information regarding a first mapping specifying a next hop interface for data elements received at the communication interfaces, wherein at least one next hop interface belongs to a set of logical interfaces. The data structure also includes information regarding a second mapping specifying a second next hop interface for certain data elements for which the next hop interface specified by the first mapping belongs to the set of logical interfaces, wherein at least one second next hop interface belongs to the plurality of communication interfaces. Additionally, the data structure includes information regarding a consolidated mapping created from the first and second mappings by replacing each portion of the first mapping that specifies a next hop interface belonging to the set of logical interfaces by a corresponding portion of the second mapping that specifies a second next hop interface.

The present invention is also applicable to a multicast environment and may be summarized as a method of generating a mapping for use by a data forwarding entity having a plurality of communication interfaces. The method includes receiving a first mapping specifying a next hop interface for data elements received at the communication interfaces, wherein at least one of the plurality of next hop interfaces specified for at least one of the certain ones of the received data elements belongs to a set of logical interfaces. The method also includes receiving a second mapping specifying a plurality of second next hop interfaces for certain data elements for which the next hop interface specified by the first mapping belongs to the set of logical interfaces, wherein at least one second next hop interface belongs to the plurality of communication interfaces. Additionally, the method includes generating a consolidated mapping from the first and second mappings by replacing at least one portion of the first mapping that specifies a next hop interface belonging to the set of logical interfaces by a corresponding portion of the second mapping that specifies a plurality of second next hop interfaces.

The present invention may also be summarized as computer-readable media tangibly embodying a program of instructions executable by a data forwarding apparatus to perform the above described method.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows a pair of routers to be replaced by a single router in accordance with an embodiment of the present invention;

FIG. 2A shows a router in accordance with an embodiment of the present invention, which is provided with a pair of mappings;

FIG. 2B shows one manner of creating a consolidated mapping from the mappings provided to the router of FIG. 2A;

FIG. 2C shows another manner of creating a consolidated mapping from the mappings provided to the router of FIG. 2A;

FIG. 3 shows an example physical implementation of a router in accordance with an embodiment of the present invention;

FIG. 4A shows a router in accordance with another embodiment of the present invention, which is provided with a pair of mappings;

FIG. 4B shows one manner of creating a partial consolidated mapping from the mappings provided to the router of FIG. 4A; and

FIG. 4C shows another manner of creating a partial consolidated mapping from the mappings provided to the router of FIG. 4A.

### DETAILED DESCRIPTION OF THE PREFERRED EMBODIMENTS

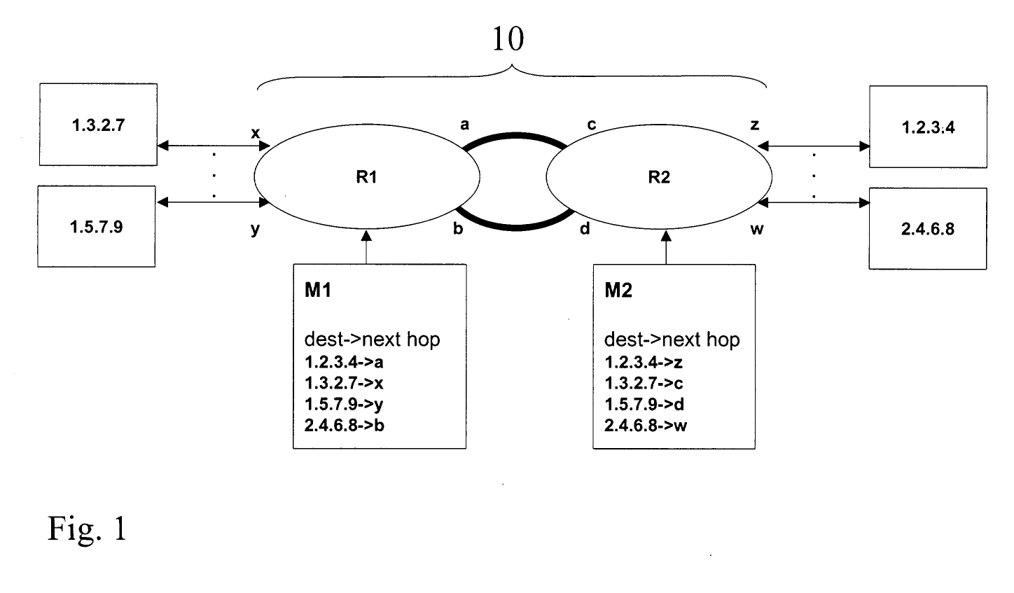

With reference to FIG. 1, there is shown a cluster of data communications forwarding systems (hereinafter referred to simply as a “cluster” 10) to be replaced by a single data communications forwarding system of the present invention. In this example, the cluster 10 includes two data communications forwarding systems, namely a first router R1 and a second router R2. In general, the components of the cluster 10 may be data communications systems other than routers and, furthermore, the number of components may be greater than two, and furthermore, the components need not be of the same type. Specific examples of data communications forwarding systems amenable to be replaced by a single data communications forwarding system of the present invention include IP routers, layer-2 switches of various types (e.g., Ethernet, Frame Relay (FR), Asynchronous Transfer Mode (ATM), Multi-Protocol Label Switching (MPLS)), circuit switches of various types (e.g., DACS, Synchronous Optical Network (SONET) Add-Drop Multiplexers (ADMs), Optical Cross-Connects (OXCs)), wireless telephony equipment, equipment that performs combinations of the above operations and most other programmable communications equipment that performs a forwarding function.

Also, in the present specification, the term “data element” is intended to encompass an element of packet-switched data (e.g., a packet or datagram) or an element of circuit-switched data (e.g., the data contained in a time slot), depending on the context in which it is described. For its part, the term “packet” is not to be construed in a limitative fashion. Rather, this term is intended to broadly encompass any statistically multiplexed unit of information. Thus, it will be clear that the present invention applies to data forwarding entities that perform either or both packet-switching and circuit-switching functions.

As can be seen in FIG. 1, the cluster 10 includes a plurality of extra-cluster interfaces x, y, z, w, as well as a plurality of intra-cluster interfaces a, b, c, d. The extra-cluster interfaces x, y, z, w, receive data elements from outside the cluster 10 and also forward routed data elements to destinations outside of the cluster 10. In this specific example, extra-cluster interfaces x, y, z, w, are connected to destinations 1.3.2.7, 1.5.7.9, 1.2.3.4, 2.4.6.8, respectively. The intra-cluster interfaces a, b, c, d, serve to connect the routers R1 and R2 to one another. Specifically, intra-cluster interface a on router R1 is connected to intra-cluster interface c on router R2, while intra-cluster interface b on router R1 is connected to intra-cluster interface d on router R2. The number of extra-cluster interfaces and intra-cluster interfaces is shown by way of illustration only; it should be understood that the data communications forwarding system of the present invention may replace a cluster 10 having a wide range of extra-cluster interfaces and intra-cluster interfaces.

Each of the routers R1, R2 typically has a control plane for storing a mapping that defines the forwarding behaviour of the particular router in question. In this case, let M1 and M2 represent the mappings associated with the routers R1 and R2, respectively. Thus, mapping M1 will define a mapping amongst the interfaces x, y, a and b, while mapping M2 will define a mapping amongst the interfaces z, w, c and d. More specifically, mappings M1 and M2 will specify a next hop interface for each data element received at one of its interfaces. The next hop interface may be looked up as a function of a source of the data element (identified by an IP address, for example), a destination of the data element (e.g., identified by an IP address, for example), a priority level associated with the data element, the identity of the interface at which the data element arrives, a connection state (e.g., for connection-oriented switching) or some other characteristic of the received data element.

By virtue of the mappings M1 and M2 and the interconnection existing between the routers R1 and R2, a data element arriving at one of the extra-cluster interfaces x, y, z, w will be forwarded either directly out through one of the extra-cluster interfaces on the same router or it will have to travel to the other router of the cluster 10, from which it will emerge at one of the extra-cluster interfaces of that other router. For example, a data element arriving at interface x will either exit the router R1 through interface y (or x, although this is rare), or it will travel to router R2 via one of the intra-cluster interfaces a, b. The data element will then emerge from router R2 via one of the extra-cluster interfaces z, w. In order for a single router to be able to successfully replace the cluster 10, the behaviour of data elements from the point of view of entering and leaving the cluster 10 via the extra-cluster interfaces x, y, z, w needs to be replicated.

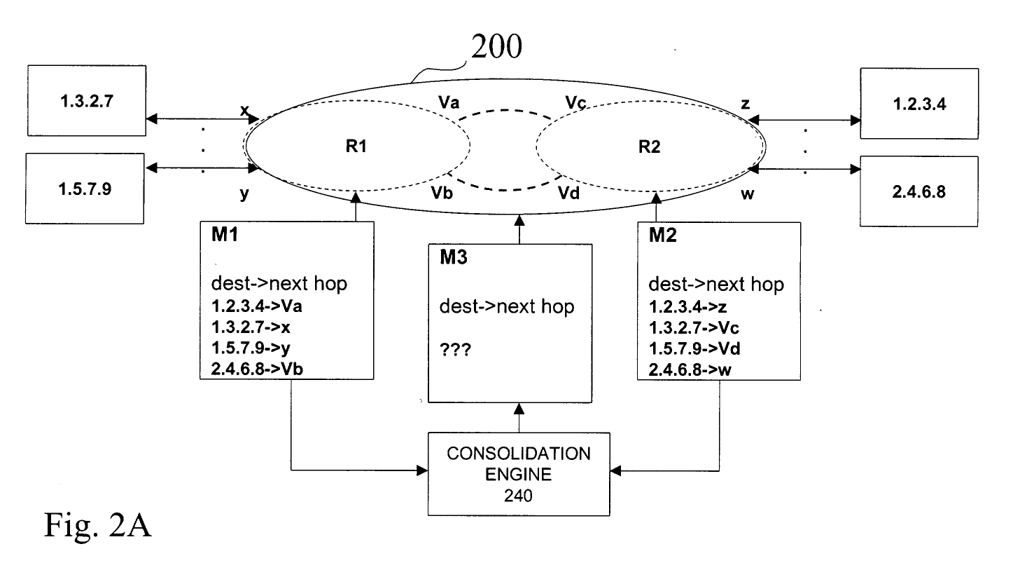

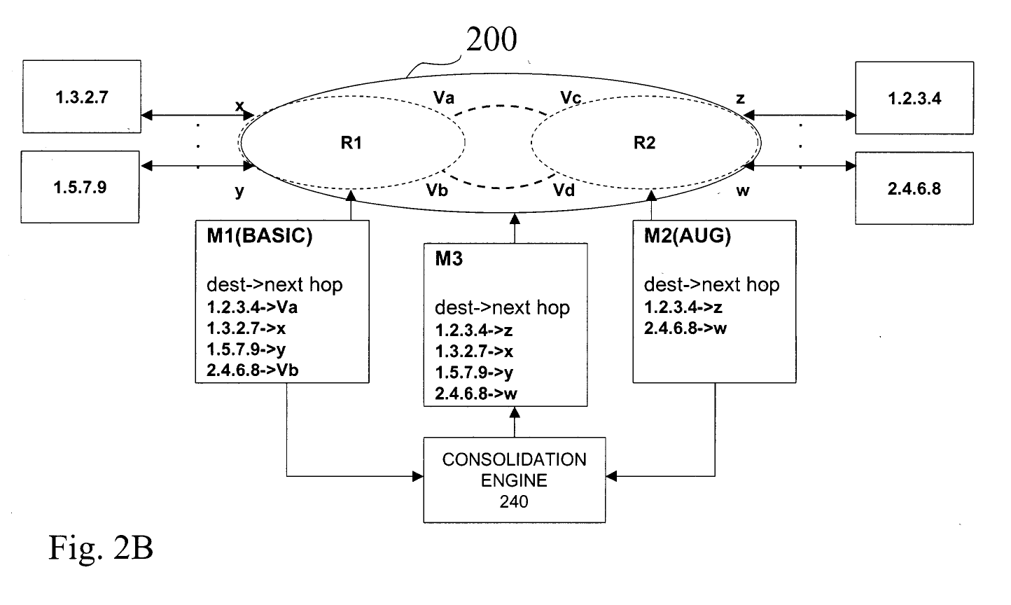

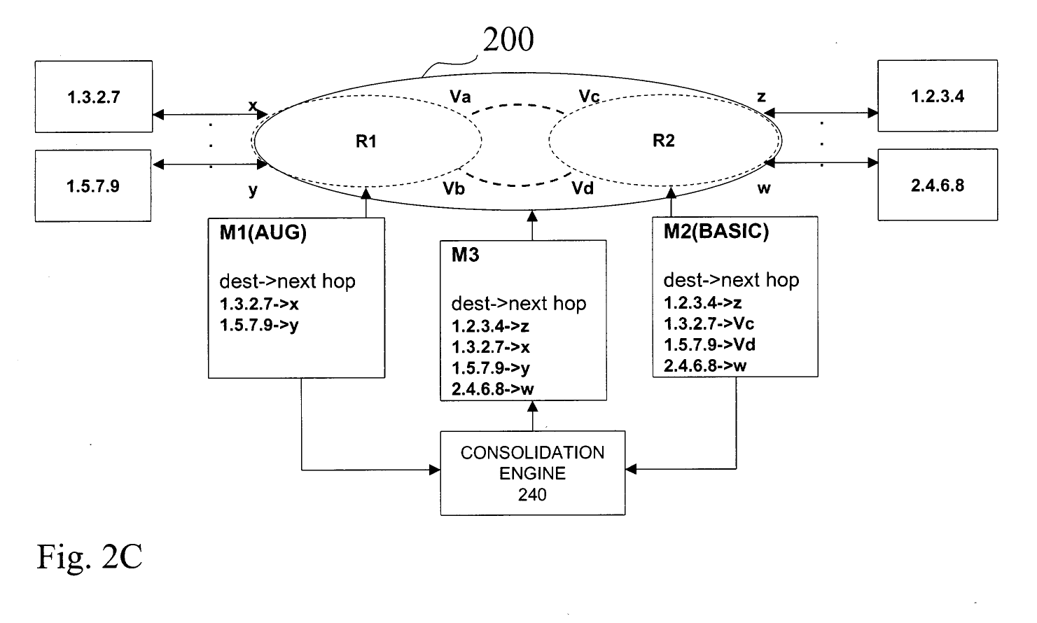

With reference to FIG. 2A, there is shown a data communications forwarding system 200 in accordance with an embodiment of the present invention. In this particular example, the data communications forwarding system 200 is a router, although it may assume other roles in accordance with the operational requirements of the invention. Viewed externally, the single router 200 is functionally equivalent to the cluster 10 described herein above with reference to FIG. 1. The routers R1 and R2, although they do not physically exist, are manifested within the router 200 in a logical form and will hereinafter be referred to as “logical routers” for convenience.

The router 200 has a data plane that receives and forwards data elements in accordance with a mapping maintained in a control plane. Data elements are received on a plurality of communication interfaces x, y, z, w corresponding to the extra-cluster interfaces x, y, z, w, of the cluster 10. However, the router 200 does not possess any communication interfaces to match the intra-cluster interfaces a, b, c, d of the cluster 10. Rather, these former intra-cluster interfaces are logical in nature and are denoted Va, Vb, Vc, Vd, in this example. Thus, it will be apparent that the router 200 does not require a greater number of communication interfaces than the number of extra-cluster interfaces of the cluster 10 it is designed to replace.

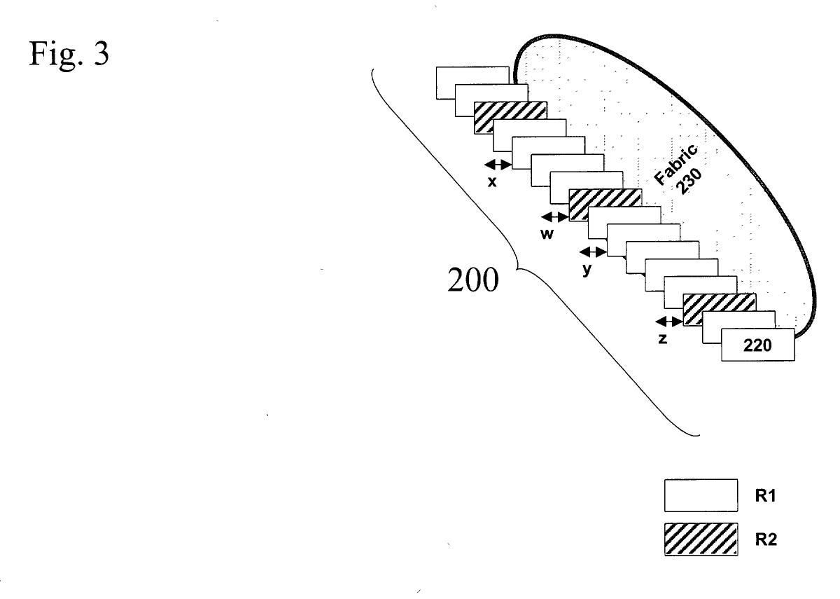

From a physical standpoint, as shown in FIG. 3, the communication interfaces x, y, z, w may reside on a plurality of line cards 220, which include processors and other hardware. The data plane of the router 200 may also physically include a switch fabric 230 to which the line cards 220 connect and which allows data elements to travel (i.e., “hop”) from one line card to another. In this example, the line cards 220 on which are located communication interfaces x and y are associated with logical router R1 (solid blocks), and the line cards 220 on which are located communication interfaces z and w are associated with logical router R2 (striped blocks). In other embodiments, the partitioning of physical resources amongst logical routers need not be on a per-line-card basis. In all cases of the router 200, however, no line cards or other physical resources are associated with the logical interfaces Va, Vb, Vc, Vd.

With continued reference to FIG. 2A, the control plane of the router 200 of the present invention maintains a mapping M3 which defines the forwarding behaviour of the router 200. The control plane may be distributed amongst the line cards 220 or it may be implemented on a set of control cards provided separately within the chassis of the router 200. The mapping M3 specifies a next hop interface for each data element received at one of the communication interfaces x, y, z, w. Since the router 200 is designed to replace the routers R1 and R2, the mapping M3 must bear some relation to the mappings M1 and M2. In fact, mappings M1 and M2, which are provided to the router 200, contain all of the information needed to create mapping M3. However, it is noted that mappings M1 and M2 involve the (no longer existent) intra-cluster interfaces and thus the mapping M3 must differ from the mappings M1 and M2. One way of consolidating the mappings M1 and M2 to arrive at the mapping M3 is now described in greater detail.

The mapping M3 is created by a consolidation engine 240, which may be implemented as a software component of the control plane. Conceptually, the consolidated mapping M3 specifies a mapping function for the physical data plane function that is equivalent to a “convolution” of the mapping functions specified by the mappings M1 and M2. As a practical matter, the consolidated mapping M3, applied once, will have the same result (as far as external operation is concerned) as applying the appropriate individual mappings M1 and M2 in the appropriate sequence.

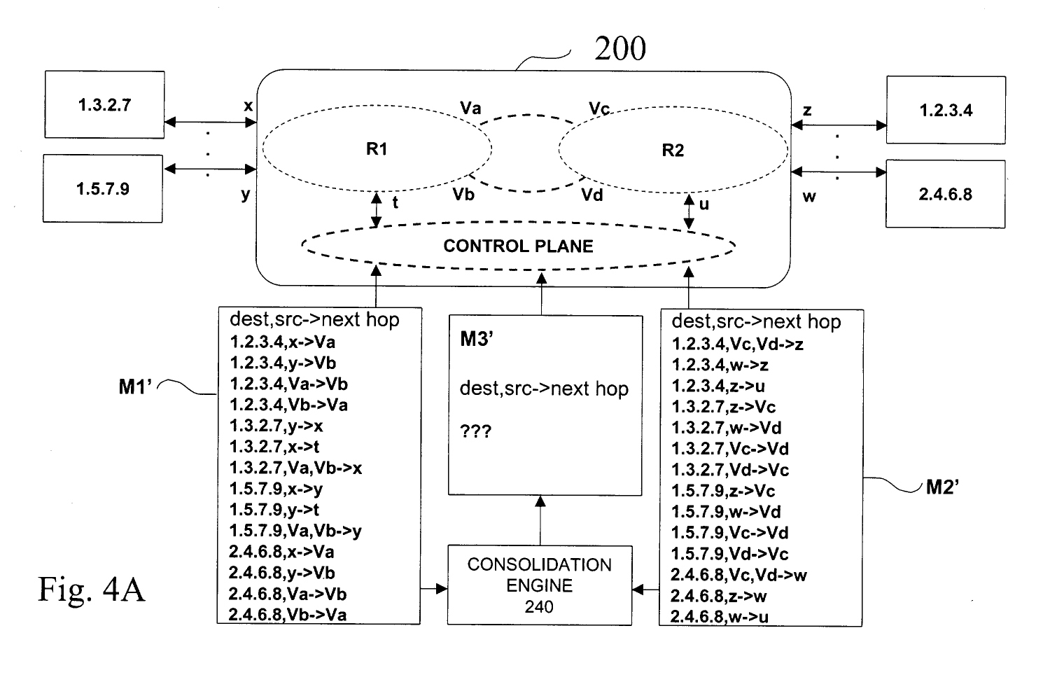

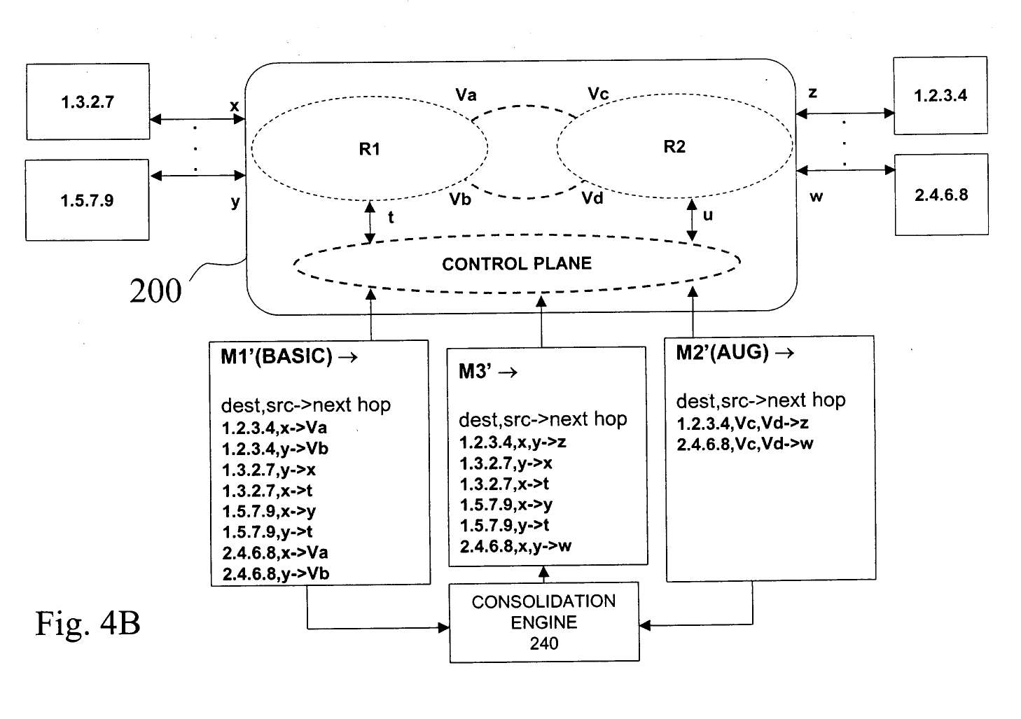

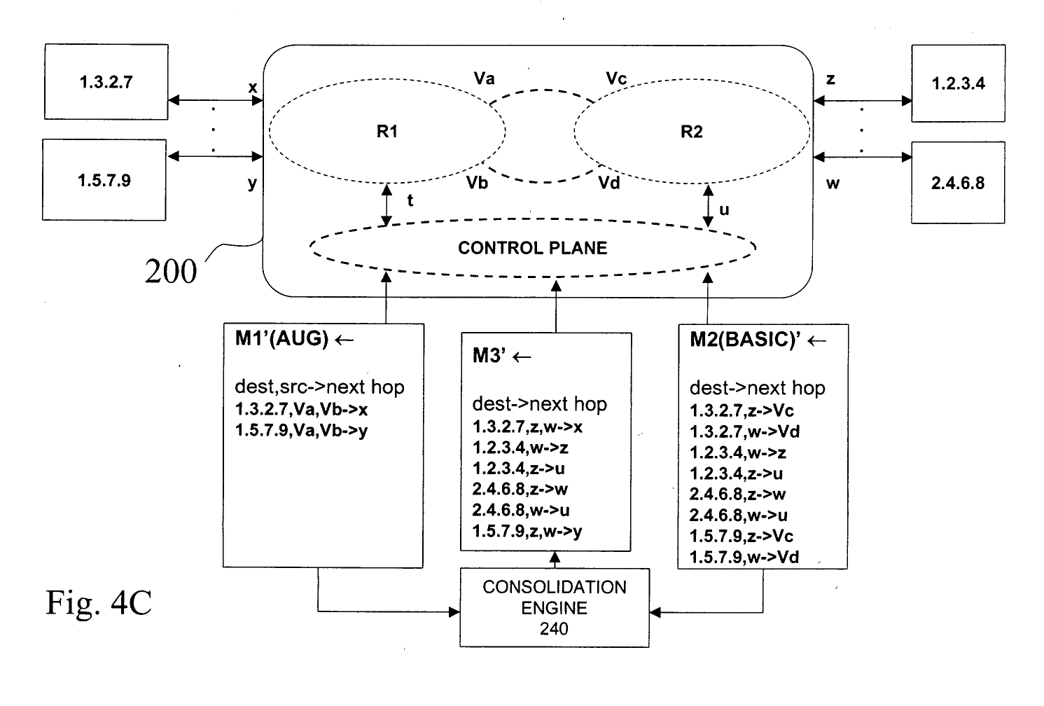

In the example of FIG. 2A, the forwarding action specified by the mapping M1 depends on the destination of each data element received at one of the communication interfaces x, y, z, w. The data plane obtains knowledge of the destination of each received data element from a header of that data element. Of interest is the fact that the forwarding action does not depend on the communication interface at which a data element is received, although it should be understood that in other cases (see FIGS. 4A through 4C), the forwarding action may indeed be dependent on the communication interface at which a data element is received and possibly on other characteristics of the received data element, such as its priority level, age, etc.

More specifically, the mapping M1 specifies that a data element with destination 1.3.2.7 is to be forwarded to communication interface x, a data element with destination 1.5.7.9 is to be forwarded to communication interface y, a data element with destination 1.2.3.4 is intended to be forwarded to logical interface Va, and a data element with destination 2.4.6.8 is intended to be forwarded to logical interface Vb. Furthermore, the mapping M2 specifies that a data element with destination 1.2.3.4 is to be forwarded to communication interface z, a data element with destination 2.4.6.8 is to be forwarded to communication interface w, a data element with destination 1.3.2.7 is intended to be forwarded to logical interface Vc, and a data element with destination 1.5.7.9 is intended to be forwarded to logical interface Vd.

In one example embodiment, the consolidated mapping M3 can be created by taking a basic portion of the mapping M1 and consolidating it with an augmented portion of the mapping M2. As shown in FIG. 2B, the basic portion of the mapping M1, denoted M1_{BASIC} is taken to be the entire mapping M1, while the augmented portion of the mapping M2, denoted M2_{AUG}, refers only to that portion of the mapping M2 in which a next hop interface is provided for those data elements that would be routed to logical router R2 by logical router R1. Hence, M2_{AUG} includes only the portion of the mapping M2 that specifies the next hop interface for data elements having a destination 1.2.3.4 or a destination 2.4.6.8, since these are the only data elements that would have been forwarded to logical router R2 by logical router R1 if these logical routers were implemented separately. Now, by replacing those portions of M1_{BASIC} which specify a forwarding action towards logical router R2 with a corresponding portion of M2_{AUG} that continues the forwarding process, one has created the mapping M3.

More specifically, the mapping M3 specifies that a data element with destination 1.3.2.7 is to be forwarded to communication interface x (as in M1_{BASIC}), a data element with destination 1.5.7.9 is to be forwarded to communication interface y (as in M1_{BASIC}), a data element with destination 1.2.3.4 is to be forwarded to communication interface z (as in M2_{AUG}), and a data element with destination 1.5.7.9 is to be forwarded to communication interface w (as in M1_{AUG}). Of note is the fact that the mapping M3 is a single-next-hop mapping function, which means that a data element is routed immediately to the same communication interface after one lookup as it would have been routed to if it had followed multiple passes (through the mappings M1 and M2). Stated differently, the net effect of the mapping M3 is identical to the net forwarding behaviour of the cluster 10 from the point of view of the communication interfaces x, y, z, w. Furthermore, no communication interfaces need to be reserved for intra-router communications. Moreover, no data element will ever be “forwarded” by the router 200 to a logical interface via the data plane, which is consistent with the notion that the logical interfaces Va, Vb, Vc, Vd do not exist as physical entities.

Alternately, the consolidated mapping M3 can be created by taking a basic portion of the mapping M2 and consolidating it with an augmented portion of the mapping M1. As shown in FIG. 2C, the basic portion of the mapping M2, denoted M2_{BASIC}, is taken to be the entire mapping M2, while the augmented portion of the mapping M1, denoted MLAUG, refers only to that portion of the mapping M1 in which a next hop interface is provided for those data elements that would be routed to logical router R1 by logical router R2. Hence, MLAUG includes only the portion of the mapping M1 that specifies the next hop interface for data elements having a destination 1.3.2.7 or a destination 1.5.7.9, since these are the only data elements that would have been forwarded to logical router R1 by logical router R2 if these logical routers were implemented separately. Now, by replacing those portions of M²_{BASIC} which specify a forwarding action towards logical router R1 with a corresponding portion of M1_{AUG} that continues the forwarding process, one has created the same mapping M3 as in FIG. 2B.

A more complex example of a forwarding action specified by the mappings M1 and M2 is now described with reference to FIGS. 4A through 4C. Specifically, in FIG. 4A, a mapping M1′ is provided, which specifies a next hop interface to which to forward a received data element based not only on the destination of the data element but also on the basis of the communication interface at which the data element is received. In this particular example, some of the communication interfaces are adapted to communicate with the control plane. This may be useful in operation, administration and maintenance functions. For example, the ability to transmit data elements to the control plane may be used to perform error detection and/or correction or to transmit control information or even changes to the mappings M1 and M2.

In order to obtain sufficient information to forward each received data element, data plane can obtain, as before, the destination of a received data element from the data element's header. In addition, the data plane can be assumed to have knowledge of the communication interface at which the data element is received, since it processes incoming data elements. Of course, it will be understood that because the mappings M1′ and M2′ are associated with logical routers R1 and R2, certain portions of each mapping will refer to interfaces that are physically non-existent, namely, logical interfaces Va, Vb, Vc, Vd.

In this specific example, the mapping M1′ specifies that a data element with destination 1.2.3.4 and received at communication interface x is intended to be forwarded to logical interface Va, a data element with destination 1.2.3.4 and received at communication interface y is intended to be forwarded to logical interface Vb, a data element with destination 1.2.3.4 and “arriving” at logical interface Va is intended to be forwarded to logical interface Vb and a data element with destination 1.2.3.4 and “arriving” at logical interface Vb is intended to be forwarded to logical interface Va. In addition, a data element with destination 1.3.2.7 and received at communication interface y is to be forwarded to communication interface x, a data element with destination 1.3.2.7 and received at communication interface x is to be forwarded to the control plane (because it should never have entered the router 200) and a data element with destination 1.3.2.7 and “arriving” at either logical interface Va or logical interface Vb is to be forwarded to communication interface x. Moreover, a data element with destination 1.5.7.9 and received at communication interface x is to be forwarded to communication interface y, a data element with destination 1.5.7.9 and received at communication interface y is to be forwarded to the control plane (because it should never have entered the router 200) and a data element with destination 1.5.7.9 and “arriving” at either logical interface Va or logical interface Vb is to be forwarded to communication interface y. Finally, a data element with destination 2.4.6.8 and received at communication interface x is intended to be forwarded to logical interface Va, a data element with destination 2.4.6.8 and received at communication interface y is intended to be forwarded to logical interface Vb, a data element with destination 2.4.6.8 and “arriving” at logical interface Va is intended to be forwarded to logical interface Vb and a data element with destination 2.4.6.8 and “arriving” at logical interface Vb is intended to be forwarded to logical interface Va.

Furthermore, the mapping M2′ specifies that a data element with destination 1.2.3.4 and “arriving” at logical interface Vc or logical interface Vd is to be forwarded to communication interface z, a data element with destination 1.2.3.4 and received at communication interface w is to be forwarded to communication interface z, a data element with destination 1.2.3.4 and received at communication interface z is to be forwarded to the control plane (because it should never have entered the router 200), a data element with destination 1.3.2.7 and arriving at communication interface z is intended to be forwarded to logical interface Vc, a data element with destination 1.3.2.7 and received at communication interface w is intended to be forwarded to logical interface Vd, a data element with destination 1.3.2.7 and “arriving” at logical interface Vc is intended to be forwarded to logical interface Vd, a data element with destination 1.3.2.7 and “arriving” at logical interface Vd is intended to be forwarded to logical interface Vc, a data element with destination 1.5.7.9 and received at communication interface z is intended to be forwarded to logical interface Vc, a data element with destination 1.5.7.9 and received at communication interface w is intended to be forwarded to logical interface Vd, a data element with destination 1.5.7.9 and “arriving” at logical interface 1.5.7.9 is intended to be forwarded to logical interface Vd, a data element with destination 1.5.7.9 and “arriving” at logical interface Vd is intended to be forwarded to logical interface Vc, a data element with destination 2.4.6.8 and “arriving” at logical interface Vc or logical interface Vd is to be forwarded to communication interface w, a data element with destination 2.4.6.8 and received and communication interface z is to be forwarded to communication interface w and a data element with destination 2.4.6.8 and received at communication interface z is to be forwarded to the control plane (because it should never have entered the router 200).

The consolidated mapping M3′ consists of two halves, the first half dealing with data elements received by the router 200 at communication interfaces x and y (resulting in the creation of the mapping M3′→) and the second half dealing with data elements received by the router 200 at communication interfaces z and w (resulting in the creation of the mapping M3′←). The creation of mapping M3′→ is illustrated in FIG. 4B, while the creation of mapping M3′← is illustrated in FIG. 4C. Of course, each of the halves of the consolidated mapping M3′ is itself a consolidated mapping and its construction falls within the scope of the present invention.

With reference to FIG. 4B, mapping M3′→ is constructed by taking a basic portion of the mapping M1′, denoted M1′→_{BASIC}, which relates to data elements received at the communication interfaces x and y, and consolidating it with an augmented portion of the mapping M2′, denoted M2′→_{AUG}, which relates to the portion of the mapping M2′ in which a next hop interface is provided for those data elements that would have been routed to logical router R2 by logical router R1. Hence, M2′ AUG includes only the portion of the mapping M2′ that specifies the next hop interface for data elements “arriving” at logical interface Vc or logical interface Vd, since these are the only data elements that would have been forwarded to logical router R2 by logical router R1 if these logical routers were implemented separately. Now, by replacing those portions of M1′→_{BASIC} which specify a forwarding action towards logical router R2 with a corresponding portion of M2′→_{AUG} that continues the forwarding process, one has created the mapping M3′→.

In the result, the mapping M3′→ specifies that a data element with destination 1.2.3.4 and received at communication interface x or communication interface y will be forwarded to communication interface z (combination of M1′→_{BASIC} and M2′_{→AUG}), a data element with destination 1.3.2.7 and received at communication interface y will be forwarded to communication interface x (as per M1′→_{BASIC}), a data element with destination 1.3.2.7 and received at communication interface x will be forwarded to the control plane (as per M1′→_{BASIC}), a data element with destination 1.5.7.9 and received at communication interface x will be forwarded to communication interface y (as per M1′→_{BASIC}), a data element with destination 1.5.7.9 and received at communication interface y will be forwarded to the control plane (as per M′→_{BASIC}) and a data element with destination 2.4.6.8 and received at communication interface x or communication interface y will be forwarded to communication interface w (combination of M1′→_{BASIC} and M2′→_{AUG}).

Of note is the fact that the mapping M3′→ is a single-next-hop mapping function, which means that a data element is routed immediately to the same communication interface after one lookup as it would have been routed to if it had followed multiple passes (through the mappings M1′→_{BASIC} and M2′→_{AUG}). Stated differently, the net effect of the mapping M3′→ is identical to the net forwarding behaviour of the cluster 10 from the point of view of data elements received at the communication interfaces x and y. Furthermore, no communication interfaces need to be reserved for intra-router communications. Moreover, no data element will ever be “forwarded” by the router 200 to a logical interface via the data plane, which is consistent with the notion that the logical interfaces Va, Vb, Vc, Vd, do not exist as physical entities.

With reference now to FIG. 4C, mapping M3′← is constructed by taking a basic portion of the mapping M2′, denoted M2′←_{BASIC}, which relates to data elements received at the communication interfaces x and y, and consolidating it with an augmented portion of the mapping M1′, denoted M1′←_{AUG}, which relates to the portion of the mapping M1′ in which a next hop interface is provided for those data elements that would have been routed to logical router R1 by logical router R2. Hence, M1′←_{AUG} includes only the portion of the mapping M1′ that specifies the next hop interface for data elements “arriving” at logical interface Va or logical interface Vb, since these are the only data elements that would have been forwarded to logical router R1 by logical router R2 if these logical routers were implemented separately. Now, by replacing those portions of M2′←_{BASIC} which specify a forwarding action towards logical router R1 with a corresponding portion of M1′←_{AUG} that continues the forwarding process, one has created the mapping M3′←.

In the result, the mapping M3′← specifies that a data element with destination 1.3.2.7 and received at communication interface z or communication interface w will be forwarded to communication interface x (combination of M2′←_{BASIC} and M1′←_{AUG}), a data element with destination 1.2.3.4 and received at communication interface w will be forwarded to communication interface z (as per M2′←_{BASIC}), a data element with destination 1.2.3.4 and received at communication interface z will be forwarded to the control plane (as per M2′←_{BASIC}), a data element with destination 2.4.6.8 and received at communication interface z will be forwarded to communication interface w (as per M2′←_{BASIC}), a data element with destination 2.4.6.8 and received at communication interface w will be forwarded to the control plane (as per M2′←_{BASIC}) and a data element with destination 1.5.7.9 and received at communication interface z or communication interface w will be forwarded to communication interface y (combination of M2′←_{BASIC} and M1′←_{AUG}).

Of note is the fact that the mapping M3′← is a single-next-hop mapping function, which means that a data element is routed immediately to the same communication interface after one lookup as it would have been routed to if it had followed multiple passes (through the mappings M2′←_{BASIC} and M1′←_{AUG}). Stated differently, the net effect of the mapping M3′ is identical to the net forwarding behaviour of the cluster 10 from the point of view of data elements received at the communication interfaces z and w. Furthermore, no communication interfaces need to be reserved for intra-router communications. Moreover, no data element will ever be “forwarded” by the router 200 to a logical interface via the data plane, which is consistent with the notion that the logical interfaces Va, Vb, Vc, Vd do not exist as physical entities.

Of course, it is possible to combine the mappings M3′→ and M3′← into a single mapping M3′, which would specify the same net forwarding behaviour as the cluster 10 from the point of view of data elements received at any of the communication interfaces x, y, z, w.

Those skilled in the art will appreciate that there are many ways to implement a consolidated mapping that has the same overall effect as multiple mappings for multiple routers, and the utility of the consolidated mapping concept is independent of the precise implementation. The result of applying the consolidated mapping to the physical data plane is that each data element is processed once by the data plane to produce the same result that would be produced if the appropriate logical router mappings were applied sequentially.

In addition to being forwarded, a received data element may undergo other actions by the router that are composite actions based on actions specified for the two logical routers R1 and R2. In accordance with an embodiment of the present invention, the final action taken by the router 200 with respect to a given data element will be a function of the path through the cluster 10 that would have been followed if the logical routers had been implemented separately. As a practical matter, some actions are independent of subsequent actions, other actions are superseded by subsequent actions, and still other actions are modified by subsequent actions. For example a first action of “encapsulate” and a second action of “de-encapsulate” would result in a final action of “do nothing”. By way of another example, the action “use priority 1” may be superseded by a subsequent action “use priority 2.”

Those skilled in the art will appreciate that the concept of a consolidated mapping function is useful for any data plane architecture, but it is particularly useful in modern high-speed switching equipment with distributed data plane processing. Note that the partitioning of the physical data plane to permit distribution is independent of the partitioning of the system into logical data communications forwarding systems. The consolidated mapping concept applies to the data plane as a whole. When the consolidated mapping is implemented on a distributed data plane, it is possible to partition the processing to align it to the logical switch partitioning, or to the data plane partitioning, or to both. The precise implementation will depend on the operational requirements of the system, as determined by those of ordinary skill in the art.

Those skilled in the art will also appreciate that the consolidated mapping concept is useful even when a convolution is not exhaustively applied. For example, in certain architectures it may be necessary to constrain the mapping functions that can be applied to the logical interfaces. This is merely a specific instance of a general phenomenon whereby different interface types have different constraints. To the extent that these capabilities differ from the capabilities of a physical interface between physical switches, the functionality of the physical system instantiating the logical switches will differ from an equivalent collection of interconnected physical switches.

Moreover, the present invention may be applied to a multicast environment. In the sense of this discussion, the term “multicast” means the receipt of a single unit of data that results in its replication and transmission to more than one egress point. This is a generalization of the way the term is used with respect to the Internet Protocol (IP). For multicast, each mapping function (for each of the logical routers) specifies a one-to-many mapping (a multicast “tree”) of the ingress space, and the consolidated mapping specifies the convolved mapping, which will also be a one-to-many mapping. In order to achieve this, the convolution follows each “branch” of the multicast tree.

Also, in most practical applications, the control planes of the logical routers R1 and R2 (taken from the above-described example) will be implemented separately within the single physical router 200, with control signaling passing among the individual control planes. However, those skilled in the art will appreciate that the present invention can also be applied to the control planes of the logical routers R1, R2 in addition to being applied to their data planes, which would effectively result in the creation of a single “consolidated” control plane.

It will be understood that the processors used in the data plane or the control plane may be each implemented as an arithmetic and logic unit (ALU) having access to a code memory (not shown) which stores program instructions for the operation of the ALU. The program instructions could be stored on a medium which is fixed, tangible and readable directly by the processor (e.g., removable diskette, CD-ROM, ROM, or fixed disk), or the program instructions could be stored remotely but transmittable to the processor via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

Those skilled in the art should also appreciate that the program instructions stored in the code memory can be compiled from a high level program written in a number of programming languages for use with many computer architectures or operating systems. For example, the high level program may be written in assembly language, while other versions may be written in a procedural programming language (e.g., “C”) or an object oriented programming language (e.g., “C++” or “JAVA”).

Those skilled in the art should further appreciate that in some embodiments of the invention, the functionality of the processors may be implemented as pre-programmed hardware or firmware elements (e.g., application specific integrated circuits (ASICs), electrically erasable programmable read-only memories (EEPROMs), etc.), or other related components.

While specific embodiments of the present invention have been described and illustrated, it will be apparent to those skilled in the art that numerous modifications and variations can be made without departing from the scope of the invention as defined in the appended claims.

We claim:

1. A method of generating a mapping for use by a data forwarding entity having a plurality of communication interfaces, comprising:
a) receiving a first mapping specifying a next hop interface for data elements received at the communication interfaces, wherein at least one next hop interface belongs to a set of logical interfaces;
b) receiving a second mapping specifying a second next hop interface for certain data elements for which the next hop interface specified by the first mapping belongs to the set of logical interfaces, wherein at least one second next hop interface belongs to the plurality of communication interfaces;
c) generating a consolidated mapping from the first and second mappings by replacing each portion of the first mapping that specifies a next hop interface belonging to the set of logical interfaces by a corresponding portion of the second mapping that specifies a second next hop interface.

2. A method as defined in claim 1, wherein at least one other next hop interface specified by the first mapping belongs to the plurality of communication interfaces and wherein generating the consolidated mapping further includes retaining each portion of the first mapping that specifies a next hop interface belonging to the plurality of communication interfaces.

3. A method as defined in claim 1, further comprising storing the consolidated mapping in a memory.

4. A method as defined in claim 3, further comprising:
d) receiving a data element at one of the communication interfaces;
e) accessing the consolidated mapping to determine a next hop interface associated with each data element received at the communication interfaces;
f) forwarding the received data element to the next hop interface determined at e).

5. A method as defined in claim 4, further comprising determining at least one characteristic of the received data element, wherein accessing the consolidated mapping includes identifying a portion of the consolidated mapping that specifies a next hop interface associated with the at least one characteristic of the received data element.

6. A method as defined in claim 1, wherein each received data element is associated with a source address, wherein the next hop interface specified by the consolidated mapping for a particular received data element is a function of the source address associated with the particular received data element.

7. A method as defined in claim 1, wherein each received data element is associated with a source address, wherein the next hop interface specified by the consolidated mapping for a particular received data element is a function of the source address associated with the particular received data element.

8. A method as defined in claim 1, wherein each received data element is associated with a destination address, wherein the next hop interface specified by the consolidated mapping for a particular received data element is a function of the destination associated with the particular received data element.

9. A method as defined in claim 1, wherein each received data element is associated with a priority level, wherein the next hop interface specified by the consolidated mapping for a particular received data element is a function of the priority level associated with the particular received data element.

10. A method as defined in claim 1, wherein each received data element is associated with an age, wherein the next hop interface specified by the consolidated mapping for a particular received data element is a function of the age associated with the particular received data element.

11. A method as defined in claim 1, wherein the next hop interface specified by the consolidated mapping for a particular received data element is a function of the communication interface at which the particular received data element was received.

12. A method as defined in claim 1, wherein each received data element is associated with a connection having a connection state, wherein the next hop interface specified by the consolidated mapping for a particular received data element is a function of the connection state of the connection associated with the particular received data element.

13. A method as defined in claim 1, wherein the first mapping further associates a corresponding first action to each data element received at one of the communication interfaces.

14. A method as defined in claim 13, wherein the second mapping further associates a corresponding second action to certain data elements for which the next hop interface specified by the first mapping is one of the logical interfaces.

15. A method as defined in claim 12, wherein the consolidated mapping further associates a corresponding third action to each data element received at one of the communication interfaces, wherein the corresponding third action is the corresponding first action if the next hop interface specified by the first mapping is one of the communication interfaces and wherein the corresponding third action is a composition of the corresponding first and second actions if the next hop interface specified by the first mapping is one of the logical interfaces.

16. A method as defined in claim 1, wherein the communication interfaces include control interfaces.

17. A data forwarding apparatus, comprising:
a) a plurality of communication interfaces at which data elements are received by the apparatus;
b) a memory for storing a first mapping, a second mapping and a consolidated mapping;
i) the first mapping specifying a next hop interface for data elements received at the communication interfaces, wherein at least one next hop interface belongs to a set of logical interfaces;
ii) the second mapping specifying a second next hop interface for certain data elements for which the next hop interface specified by the first mapping belongs to the set of logical interfaces, wherein at least one second next hop interface belongs to the plurality of communication interfaces;
iii) the consolidated mapping specifying a next hop interface for data elements received at the communication interfaces, wherein no next hop interface specified by the consolidated mapping belongs to the set of logical interfaces;
c) a processing entity connected to said physical interfaces and said memory, said processing entity being capable of:
i) generating the consolidated mapping from the first and second mappings by replacing each portion of the first mapping that specifies a next hop interface belonging to the set of logical interfaces by a corresponding portion of the second mapping that specifies a second next hop interface;
ii) accessing the consolidated mapping to determine a next hop interface associated with each data element received at the communication interfaces;
iii) forwarding the received data element to the next hop interface determined at ii).

18. A data forwarding apparatus as defined in claim 17, wherein the first mapping further associates a corresponding first action to each data element received at one of the communication interfaces.

19. A data forwarding apparatus as defined in claim 18, wherein the second mapping further associates a corresponding second action to certain data elements for which the next hop interface specified by the first mapping is one of the logical interfaces

20. A data forwarding apparatus as defined in claim 19 wherein the consolidated mapping further associates a corresponding third action to each data element received at one of the communication interfaces, wherein the corresponding third action is the corresponding first action if the next hop interface specified by the first mapping is one of the communication interfaces and wherein the corresponding third action is a composition of the corresponding first and second actions if the next hop interface specified by the first mapping is one of the logical interfaces.

21. A data forwarding apparatus as defined in claim 17, further comprising a plurality of line cards amongst which the communication interfaces are distributed.

22. A data forwarding apparatus as defined in claim 21, further comprising a plurality of physical data ports distributed amongst the line cards.

23. A data forwarding apparatus as defined in claim 22, wherein each of the communication interfaces is one of the physical data ports.

24. A data forwarding apparatus as defined in claim 22, wherein plural ones of the communication interfaces share a common one of the physical data ports.

25. A memory for storing data for access by an application program being executed on a data processing system having a plurality of communication interfaces, comprising:
a) a data structure stored in the memory, said data structure including information regarding a first mapping specifying a next hop interface for data elements received at the communication interfaces, wherein at least one next hop interface belongs to a set of logical interfaces;
g) said data structure including information regarding a second mapping specifying a second next hop interface for certain data elements for which the next hop interface specified by the first mapping belongs to the set of logical interfaces, wherein at least one second next hop interface belongs to the plurality of communication interfaces;
h) said data structure including information regarding a consolidated mapping created from the first and second mappings by replacing each portion of the first mapping that specifies a next hop interface belonging to the set of logical interfaces by a corresponding portion of the second mapping that specifies a second next hop interface.

26. Computer-readable media tangibly embodying a program of instructions executable by a data forwarding apparatus to perform a method of generating a mapping, the data forwarding entity having a plurality of communication interfaces, the method comprising:
a) receiving a first mapping specifying a next hop interface for data elements received at the communication interfaces, wherein at least one next hop interface belongs to a set of logical interfaces;
b) receiving a second mapping specifying a second next hop interface for certain data elements for which the next hop interface specified by the first mapping belongs to the set of logical interfaces, wherein at least one second next hop interface belongs to the plurality of communication interfaces;
c) generating a consolidated mapping from the first and second mappings by replacing each portion of the first mapping that specifies a next hop interface belonging to the set of logical interfaces by a corresponding portion of the second mapping that specifies a second next hop interface.

27. A method of generating a mapping for use by a data forwarding entity having a plurality of communication interfaces, comprising:
a) receiving a first mapping specifying a next hop interface for data elements received at the communication interfaces, wherein at least one of the plurality of next hop interfaces specified for at least one of the certain ones of the received data elements belongs to a set of logical interfaces;
b) receiving a second mapping specifying a plurality of second next hop interfaces for certain data elements for which the next hop interface specified by the first mapping belongs to the set of logical interfaces, wherein at least one second next hop interface belongs to the plurality of communication interfaces;
c) generating a consolidated mapping from the first and second mappings by replacing at least one portion of the first mapping that specifies a next hop interface belonging to the set of logical interfaces by a corresponding portion of the second mapping that specifies a plurality of second next hop interfaces.

28. A data forwarding apparatus, comprising:
a) a plurality of communication interfaces at which data elements are received by the apparatus;
b) a memory for storing a first mapping, a second mapping, a third mapping and a consolidated mapping;
i) the first mapping specifying a next hop interface for data elements received at the communication interfaces, wherein at least one next hop interface belongs to a set of logical interfaces;
ii) the second mapping specifying a second next hop interface for certain data elements for which the next hop interface specified by the first mapping belongs to the set of logical interfaces, wherein at least one second next hop interface belongs to the plurality of communication interfaces;
iii) the third mapping specifying a third next hop interface for certain data elements for which the next hop interface specified by the first mapping belongs to the set of logical interfaces, wherein at least one third next hop interface belongs to the plurality of communication interfaces;
iv) the consolidated mapping specifying a next hop interface for data elements received at the communication interfaces, wherein no next hop interface specified by the consolidated mapping belongs to the set of logical interfaces;
c) a processing entity connected to said physical interfaces and said memory, said processing entity being capable of:
i) generating the consolidated mapping from the first, second and third mappings by replacing certain portions of the first mapping that specify a next hop interface belonging to the set of logical interfaces by corresponding portions of the second mapping that specify a second next hop interface and by replacing certain portions of the first mapping that specify a next hop interface belonging to the set of logical interfaces by corresponding portions of the third mapping that specify a third next hop interface;
ii) accessing the consolidated mapping to determine a next hop interface associated with each data element received at the communication interfaces;
iii) forwarding the received data element to the next hop interface determined at ii).
